(19) United States
(12) Patent Application Publication
(10) Pub. No.: US 2024/0400433 A1
(43) Pub. Date: Dec. 5, 2024

(54) EMULSION POLYMER TO INCREASE CAKE SOLIDS IN CENTRIFUGES

(71) Applicant: SOLENIS TECHNOLOGIES, L.P., Wilmington, DE (US)

(72) Inventors: Nathalie Bruzzano, Duisburg (DE); Markus Bröcher, Mühlheim an der Ruhr (DE)

(73) Assignee: SOLENIS TECHNOLOGIES, L.P., Wilmington, DE (US)

(21) Appl. No.: 18/679,683

(22) Filed: May 31, 2024

Related U.S. Application Data
(60) Provisional application No. 63/505,713, filed on Jun. 2, 2023.

(51) Int. Cl. C02F 11/147; C02F 103/10; C02F 103/28; C02F 103/34; C08L 33/26

(52) U.S. Cl. CPC C02F 11/147; C08L 33/26; C02F 2103/10; C02F 2103/28; C02F 2103/34; C08L 2201/52; C08L 2312/00

(57) ABSTRACT

The present compositions and methods relate to an interpenetrating polymer network (IPN) composition comprising a two-step polymerization. In a first step, a first inverse water-in-oil emulsion polymer is prepared and wherein a second inverse water-in-oil emulsion is combined with the first inverse water-in-oil emulsion and wherein polymerization of the second inverse water-in-oil emulsion is initiated in-situ with the first inverse water-in-oil emulsion polymer, producing a second inverse water-in-oil emulsion polymer that is physically interlaced or cross-linked with the first inverse water-in-oil emulsion creating an interpenetrating polymer network (IPN) composition.

### CROSS REFERENCE TO RELATED APPLICATIONS

This application claims the benefit of U.S. Provisional application No. 63/505,713, filed 2 Jun. 2023, the entire contents of which are hereby incorporated by reference.

### TECHNICAL FIELD

The present compositions and methods generally relates to dewatering aqueous sludge that is produced by wastewater or sewage treatment facilities such as from municipal and industrial processes. The composition relates to an interpenetrating polymer network (IPN) composition comprising a two-step polymerization of a first cross-linked cPAM emulsion followed by an in-situ polymerization of a second cross-linked/branched cPAM emulsion in the polymerized product of the first cross-linked cPAM emulsion.

### BACKGROUND

The effluent streams coming from the processes mentioned above generally contain waste solids that cannot be directly recycled and are conveyed by a sewerage system to a wastewater treatment plant facility. The effluent stream goes through a series of operations depending on the particular industry and set-up of the wastewater treatment facility, to concentrate and dewater the waste solids thereby producing a sludge. Ultimately, the industrial effluent stream is passed through a filter press, such as, a chamber filter press, plate filter press, frame filter press, membrane filter press, screw filter press and belt filter press or through a centrifuge, wherein the waste solids are concentrated into a primary sludge or filter cake and the filtered wastewater from the press or centrifuge is further processed until it is fit for discharge or reuse.

A typical sewage treatment plant takes in raw sewage and produces solids and clarified water. Typically the raw sewage is treated in a primary sedimentation stage to form a primary sludge and supernatant, the supernatant is subjected to biological treatment and then a secondary sedimentation stage to form a secondary sludge and clarified liquor, which is often subjected to further treatment before discharge.

It is standard practice to dewater the sludge by mixing a dose of polymeric flocculant into that sludge at a dosing point, and then substantially immediately subjecting the sludge to the dewatering process and thereby forming a cake and a reject liquor. The dewatering process may be centrifugation or may be by processes such as filter pressing or belt pressing.

In many countries, for regulatory reasons, most sludge cake is going to landfill. For landfill, the cake must be drier than 40% and also the amount of sludge going into any landfill must not be greater than 8% (mixture ratio). Therefore, it is desirable (i) to increase the content of separated dry matter (OS), if possible, above about 40 wt.-%, i.e. to keep the sludge cake moisture below about 60 wt.-% using current processes.

In conventional processes of dewatering aqueous sludge various ionic, anionic, and cationic polymers have been added to aqueous sludge as polymeric flocculants to induce flocculation formation of the solid materials in the sludge. Other methods have included adding quick lime (CaO) to the aqueous sludge in order to increase dry matter contents (OS). However, the addition of quick lime is expensive and laborious Therefore, there is a demand for simple processes for dewatering sludge which achieves high solids contents. In particular, it is an objective to increase the residual dry matter in the filter cake of dewatered sludge and to decrease the moisture content in the filter cake, respectively.

Therefore, it was an objective to provide copolymer compositions that show improved performance as a dewatering aid for sludge dewatering in wastewater and sewage treatment.

What was found was that a second inverse water-in-oil emulsion polymer that is physically interlaced with a first inverse water-in-oil emulsion polymer and thereby creating an interpenetrating polymer network (IPN) composition, has improved efficacy in dewatering aqueous sludge.

### BRIEF SUMMARY

Provided are compositions and methods related to the dewatering of aqueous sludge. The composition is made up of an interpenetrating polymer network (IPN) that includes a first inverse water-in-oil emulsion polymer; and a second inverse water-in-oil emulsion polymer physically interlaced with the first inverse water-in-oil emulsion polymer. The first inverse water-in-oil emulsion polymer includes the polymerization reaction product of a first ethylenically unsaturated nonionic monomer chosen from acrylamides and derivatives thereof, an acrylic acid and derivatives thereof, and combinations thereof; a first ethylenically unsaturated cationic monomer; and a first cross-linking agent. The second inverse water-in-oil emulsion polymer includes the polymerization reaction product of a second ethylenically unsaturated nonionic monomer chosen from acrylamides and derivatives thereof, acrylic acids and derivatives thereof, and combinations thereof; a second ethylenically unsaturated cationic monomer; and a second cross-linking agent producing a second inverse water-in-oil emulsion polymer that is physically interlaced or cross-linked with the first inverse water-in-oil emulsion creating an interpenetrating polymer network (IPN) composition.

Also provided is a method of dewatering aqueous sludge that includes treating the aqueous sludge with an interpenetrating network emulsion polymer composition that includes a first step that includes preparing a first inverse water-in-oil emulsion polymer comprising the polymerization reaction product of a first ethylenically unsaturated nonionic monomer chosen from acrylamides and derivatives thereof, an acrylic acid and derivatives thereof, and can be combinations thereof. The first inverse water-in-oil emulsion polymer also includes a first ethylenically unsaturated cationic monomer; and a first cross-linking agent. In a second step, a second inverse water-in-oil emulsion polymer is prepared that comprises the polymerization reaction product of a second ethylenically unsaturated nonionic monomer chosen from acrylamides and derivatives thereof, acrylic acids and derivatives thereof, and combinations thereof. The second inverse water-in-oil emulsion polymer also includes a second ethylenically unsaturated cationic monomer; and a second cross-linking agent. The polymerization of the second inverse water-in-oil emulsion polymer is initiated in-situ with the first inverse water-in-oil emulsion polymer, producing a second inverse water-in-oil emulsion polymer that is physically interlaced or cross-linked with the first inverse water-in-oil emulsion polymer creating an interpenetrating polymer network (IPN) composition.

The present disclosure also relates to a method of increasing filter cake dryness in sludge dewatering processes that treating the aqueous sludge with an interpenetrating network emulsion polymer composition that includes a first step that includes preparing a first inverse water-in-oil emulsion polymer comprising the polymerization reaction product of a first ethylenically unsaturated nonionic monomer chosen from acrylamides and derivatives thereof, an acrylic acid and derivatives thereof, and can be combinations thereof. The first inverse water-in-oil emulsion polymer also includes a first ethylenically unsaturated cationic monomer; and a first cross-linking agent. In in a second step, a second inverse water-in-oil emulsion polymer is prepared that comprises the polymerization reaction product of a second ethylenically unsaturated nonionic monomer chosen from acrylamides and derivatives thereof, acrylic acids and derivatives thereof, and combinations thereof. The second inverse water-in-oil emulsion polymer also includes a second ethylenically unsaturated cationic monomer; and a second cross-linking agent. The polymerization of the second inverse water-in-oil emulsion polymer is initiated in-situ with the first inverse water-in-oil emulsion polymer, producing a second inverse water-in-oil emulsion polymer that is physically interlaced or crosslinked with the first inverse water-in-oil emulsion polymer creating an interpenetrating polymer network (IPN) composition.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The present disclosure will hereinafter be described in conjunction with the following drawing FIGURES, wherein like numerals denote like elements, and wherein:

FIG. 1, illustrates dewatering results of an aqueous sludge from three European mills after treatment with the current composition.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “about” can alternatively be understood as implying the exact value stated. Unless otherwise clear from the context, all numerical values provided herein are modified by the term “about.”

The aqueous sludge to be dewatered by the process according to the invention is not particularly limited. The aqueous sludge as a starting material comes from, for example, mining sludge, municipal sludge, and industrial sludge. It may be digested sludge, activated sludge, coarse sludge, raw sludge, and the like, and mixtures thereof.

Provided are compositions and methods related to the dewatering of aqueous sludge. The composition is made up of an interpenetrating polymer network (IPN) that includes a first inverse water-in-oil emulsion polymer; and a second inverse water-in-oil emulsion polymer physically interlaced with the first inverse water-in-oil emulsion polymer. The first inverse water-in-oil emulsion polymer includes the polymerization reaction product of a first ethylenically unsaturated nonionic monomer chosen from acrylamides and derivatives such as radically polymerizable non-ionic monomers chosen from the group consisting of (meth)acrylamide, N-methyl(meth)acrylamide, N,N-dimethyl(meth)acrylamide, N-ethyl(meth)acrylamide, N,N-diethyl(meth)acrylamide, N-methyl-N-ethyl(meth)-acrylamide, N-isopropyl(meth)acrylamide, and N-hydroxyethyl(meth)acrylamide, an acrylic acid and derivatives thereof, and combinations thereof; a first ethylenically unsaturated cationic monomer; and a first cross-linking agent. The second inverse water-in-oil emulsion polymer includes the polymerization reaction product of a second ethylenically unsaturated nonionic monomer chosen from acrylamides and derivatives thereof, acrylic acids and derivatives thereof, and combinations thereof; a second ethylenically unsaturated cationic monomer; and a second cross-linking agent. The result is the second inverse water-in-oil emulsion is physically interlaced or cross-linked with the first inverse water-in-oil emulsion polymer creating an interpenetrating polymer network (IPN) composition.

In some aspects of the composition, the ratio of the first inverse water-in-oil emulsion polymer to the second inverse water-in-oil emulsion polymer is about 80:20 to about 20:80, based on the total weight of the IPN composition.

In other aspects the ratio of the first inverse water-in-oil emulsion polymer to the second inverse water-in-oil emulsion polymer is from about 1:3, or 1:1 or about 3:1 based on the total weight of the IPN composition.

In other aspects of the composition, the first and second ethylenically unsaturated nonionic monomer is the same or different and comprises an acrylamide or derivatives thereof.

In other aspects of the composition, the first and second ethylenically unsaturated cationic monomer is the same or different and chosen from (acryloyloxy)ethyl)trimethylammonium chloride, 2-acryloxyethyltrimethylammonium chloride, dimethylaminocthyl acrylate, dimethylaminocthyl acrylate methyl chloride quat., 2-((1-oxo-2-propenyl)oxy)-N,N,N-trimethylethanaminium chloride, (2-(dimethylamino)ethyl acrylate methochloride), N,N,N-trimethyl-2-((1-oxo-2-propenyl)oxy)chloride, (2-(acryloyloxy)ethyl)trimethylammonium chloride, (2-((1-oxo-2-propenyl)oxy)-N,N,N-trimethylchloride, N,N,N-trimethyl-2-((1-oxo-2-propenyl)oxy)chloride, (2-acryloyloxyethyl)-N,N,N-trimethylammonium chloride, 2-(acryloyloxy)-N,N,N-trimethylethanaminium chloride, and combinations thereof.

In some aspects of the composition, the first and second cross-linking agent is the same or different and chosen from N,N-methylene bis acrylamide (MBA), tetraallyl ammonium chloride (TAAC), and combinations thereof.

In yet other aspects of the composition, the first and second cross-linking agent is independently present in an amount of about 0.5 ppm to about 25 ppm by weight or about 1.0 ppm to about 20 ppm by weight, based on the total weight of IPN composition.

In other aspects of the composition, the first and/or second water-in-oil emulsion polymer further comprises an additive chosen from chelating agents, surfactants, stabilizers, oils, and combinations thereof.

Also provided is a method of dewatering aqueous sludge that includes treating the aqueous sludge with an interpenetrating network emulsion polymer composition. The method includes in a first step, preparing a first inverse water-in-oil emulsion polymer comprising the polymerization reaction product of a first ethylenically unsaturated nonionic monomer chosen from acrylamides and derivatives thereof, an acrylic acid and derivatives thereof, and combinations thereof; a first ethylenically unsaturated cationic monomer; and a first cross-linking agent.

In a second step, a second inverse water-in-oil emulsion polymer is prepared comprising the polymerization reaction product of a second ethylenically unsaturated nonionic monomer chosen from acrylamides and derivatives thereof, acrylic acids and derivatives thereof, and combinations thereof; a second ethylenically unsaturated cationic monomer; and a second cross-linking agent.

The second ethylenically unsaturated nonionic monomer, second ethylenically unsaturated cationic monomer, and second cross-linking agent is added to the first inverse water-in-oil emulsion polymer of the first step and the polymerization of the second inverse water-in-oil emulsion polymer is initiated in-situ with the first inverse water-in-oil emulsion polymer thereby producing a second inverse water-in-oil emulsion polymer that is physically interlaced or crosslinked with the first inverse water-in-oil emulsion polymer and creating an interpenetrating polymer network (IPN) composition.

In some aspects of the method, the polymerization in-situ is initiated using an initiator chosen from peroxides, persulfates, and azo compounds, 2,2′-azobis(2,4-dimethyl valeronitrile.

In some aspects of the method, the polymerization of the second water-in-oil emulsion in-situ with the first water-in-oil emulsion polymer is initiated with a charge of initiator in an amount of about 250 ppm or less based on the total weight of the IPN composition.

In yet other aspects of the method, the initiator is present in an amount of about 0.0025 wt. % to about 0.0075 wt. %, or about 0.0040 wt. % to about 70%, or about 0.0050 wt. % to about 0.0065 wt. %, based on the total weight of the IPN composition.

In some aspects of the method, the first and second ethylenically unsaturated nonionic monomer is the same or different and comprises an acrylamide or derivatives such as radically polymerizable monomers comprise a radically polymerizable non-ionic monomer according to general formula (I) which is selected from the group consisting of (meth)acrylamide, N-methyl(meth)acrylamide, N,N-dimethyl(meth)acrylamide, N-ethyl(meth)acrylamide, N,N-diethyl(meth)acrylamide, N-methyl-N-ethyl(meth)-acrylamide, N-isopropyl(meth)acrylamide, and N-hydroxyethyl(meth)acrylamide.

In still other aspects of the method, the first and second ethylenically unsaturated cationic monomer is the same or different and is chosen from acryloyloxy)ethyl)trimethylammonium chloride, 2-acryloxyethyltrimethylammonium chloride, dimethylaminoethyl acrylate, dimethylaminoethyl acrylate methyl chloride quat., 2-((1-oxo-2-propenyl)oxy)-N,N,N-trimethylethanaminium chloride, (2-(dimethylamino)ethyl acrylate methochloride), N,N,N-trimethyl-2-((1-oxo-2-propenyl)oxy)chloride, (2-(acryloyloxy)ethyl)trimethylammonium chloride, (2-((1-oxo-2-propenyl)oxy)-N,N,N-trimethylchloride, N,N,N-trimethyl-2-((1-oxo-2-propenyl)oxy)chloride, (2-acryloyloxyethyl)-N,N,N-trimethylammonium chloride, 2-(acryloyloxy)-N,N,N-trimethylethanaminium chloride, and combinations thereof.

In some aspects of the method, the first and second cross-linking agent is the same or different and is chosen from is chosen from N,N-methylene bis acrylamide (MBA), tetraallyl ammonium chloride (TAAC), and combinations thereof.

In other aspects of the method, the first and second cross-linking agent is independently present in an amount of about 0.5 ppm to about 25 ppm by weight or about 1.0 ppm to about 20 ppm by weight, based on the total weight of the first or second water-in-oil emulsion polymer, respectively.

In some aspects of the method, the aqueous sludge being treated is from waste-water from municipal processes, industrial processes, papermaking processes, or mining sludge coming from tailings dewatering.

Also currently provided is a method of increasing cake dryness in sludge dewatering processes by treating the aqueous sludge with an interpenetrating network emulsion polymer composition. The method includes two-steps wherein in a first step a first inverse water-in-oil emulsion polymer is prepared. The first water-in-oil emulsion polymer comprising the polymerization reaction product of a first ethylenically unsaturated nonionic monomer chosen from acrylamides and derivatives thereof, an acrylic acid and derivatives thereof, and combinations thereof, a first ethylenically unsaturated cationic monomer and a first cross-linking agent.

In a second step, a second inverse water-in-oil emulsion polymer is prepared and is the polymerization reaction product of a second ethylenically unsaturated nonionic monomer chosen from acrylamides and derivatives thereof, acrylic acids and derivatives thereof, and combinations thereof, a second ethylenically unsaturated cationic monomer, and a second cross-linking agent.

The second ethylenically unsaturated nonionic monomer, second ethylenically unsaturated cationic monomer, and second cross-linking agent is added to the first inverse water-in-oil emulsion polymer of the first step and the polymerization of the second inverse water-in-oil emulsion polymer is initiated in-situ with the first inverse water-in-oil emulsion polymer thereby producing a second inverse water-in-oil emulsion polymer that is physically interlaced or crosslinked with the first inverse water-in-oil emulsion polymer and creating an interpenetrating polymer network (IPN) composition.

In some aspects of the method, the polymerization in-situ is initiated using an initiator chosen from peroxides, persulfates, and azo compounds such as 2,2′-azobis(2,4-dimethyl valeronitrile.

In some aspects of the method, the polymerization of the second water-in-oil emulsion in-situ with the first water-in-oil emulsion polymer is initiated with a charge of initiator in an amount of about 250 ppm or less based on the total weight of the IPN composition.

In yet other aspects of the method, the initiator is present in an amount of about 0.0025 wt. % to about 0.0075 wt. %, or about 0.0040 wt. % to about 70%, or about 0.0050 wt. % to about 0.0065 wt. %, based on the total weight of the IPN composition.

In some aspects of the method, the first and second ethylenically unsaturated nonionic monomer is the same or different and comprises an acrylamide or derivatives such as radically polymerizable monomers comprise a radically polymerizable non-ionic monomer according to general formula (I) which is selected from the group consisting of (meth)acrylamide, N-methyl(meth)acrylamide, N,N-dimethyl(meth)acrylamide, N-ethyl(meth)acrylamide, N,N-diethyl(meth)acrylamide, N-methyl-N-ethyl(meth)-acrylamide, N-isopropyl(meth)acrylamide, and N-hydroxyethyl(meth)acrylamide.

In still other aspects of the method, the first and second ethylenically unsaturated cationic monomer is the same or different and is chosen from acryloyloxy)ethyl)trimethylammonium chloride, 2-acryloxyethyltrimethylammonium chloride, dimethylaminoethyl acrylate, dimethylaminoethyl acrylate methyl chloride quat., 2-((1-oxo-2-propenyl)oxy)-N,N,N-trimethylethanaminium chloride, (2-(dimethylamino)ethyl acrylate methochloride), N,N,N-trimethyl-2-((1-oxo-2-propenyl)oxy)chloride, (2-(acryloyloxy)ethyl)trimethylammonium chloride, (2-((1-oxo-2-propenyl)oxy)-N,N,N-trimethylchloride, N,N,N-trimethyl-2-((1-oxo-2-propenyl)oxy)chloride, (2-acryloyloxyethyl)-N,N,N-trimethylammonium chloride, 2-(acryloyloxy)-N,N,N-trimethylethanaminium chloride, and combinations thereof.

In some aspects of the method, the first and second cross-linking agent is the same or different and is chosen from is chosen from N,N-methylene bis acrylamide (MBA), tetraallyl ammonium chloride (TAAC), and combinations thereof.

In other aspects of the method, the first and second cross-linking agent is independently present in an amount of about 0.5 ppm to about 25 ppm by weight or about 1.0 ppm to about 20 ppm by weight, based on the total weight of the first or second water-in-oil emulsion polymer, respectively.

In some aspects of the method, the aqueous sludge being treated is from waste-water from municipal processes, industrial processes, papermaking processes, or mining sludge coming from tailings dewatering.

### EXAMPLES

### Preparation of Standard Compositions

In a first 2-liter beaker an aqueous phase composition was prepared using a mixture of 276 grams (g) acrylamide (50 wt %), 0.6 g Trilon®C (pentasodium diethylenetriaminepentaacetate, chelating agent), 394 g ADAME® Quat (80 wt %, cationic acrylic monomers), 90 g water, and 0.1 formic acid The mixture was added to a first 2-liter beaker and stirred. The pH of the mixture was adjusted to pH 3 using sulphuric acid.

In a second 2-liter beaker, an organic or oil phase composition was prepared by mixing 20 grams (g) Zephrym® 7053 (emulsifier), 3 g Degacryl® 3059 L (methacrylic emulsifier), 12.7 g Intrasol®FA1218/5 (ethoxylated fatty alcohol surfactant) and 249 g paraffin oil.

The aqueous phase was then charged to the oil phase under vigorous stirring followed by mixing with a homogenizer to obtain a stable water-in-oil inverse emulsion. The resulting emulsion was placed into a 2-liter glass reaction vessel equipped with an anchor stirrer, thermometer and a distillation device and the emulsion was evacuated. The temperature of the emulsion was adjusted to 63±1° C. after 30 min of air stripping.

The polymerization was initiated by an initial charge of a 1 wt. % 2,2′-azobis(2,4-dimethyl valeronitrile (15 g of V-65, i.e. azo initiator in oil). The amount of distillate collected under negative pressure was 110 ml. After the distillation step, the vacuum was removed. The residual monomers react adiabatically reaching a maximum temperature of 70° C. The emulsion was stirred for an additional 15 minutes, and vacuum was again applied, and the temperature of the composition was allowed to cool to 40° C. At this time, 2 g sodium peroxodisulfate (25 wt. % of the total emulsion) and 11 g sodium bisulfite (25 wt. % of the total emulsion) were added to the composition to reduce the monomer content. As a last step, an activator was added under stirring to the final product.

### Preparation of the Two-Step Interpenetrating Network Emulsion

In a First Step: A first 2-liter beaker an aqueous phase composition was prepared using a mixture 138 g acrylamide (50 wt %), 0.3 g Trilon C, 197 g ADAME Quat (80 wt %), 45 g water, 0.6 ppm N,N′-methylene bis acrylamide and 1.6 g formic acid. The mixture was stirred, and the pH of the mixture was adjusted to pH 3 using sulphuric acid.

The organic phase was prepared by mixing 5.2 g Imbentin T/080, 8.2 g sorbitan monooleate, and 130 g paraffin oil in a second 2 L beaker. The aqueous phase was then charged to the oil phase under vigorous stirring followed by mixing with a homogenizer to obtain a stable inverse water-in-oil emulsion.

The inverse emulsion was placed into a 2 L glass reaction vessel equipped with an anchor stirrer, thermometer and a distillation device and the emulsion placed under vacuum of about 20 to 50 millibar (mbar). The temperature of the emulsion was adjusted to 63±1° C. after 30 min of air stripping. The polymerization was initiated by an initial charge of a 1 wt. % V-65 in oil. The amount of distillate under negative pressure was 60 ml. After the distillation, the vacuum was removed. The residual monomers could react adiabatically reaching a maximum temperature of 70° C. The emulsion was stirred for an additional 15 minutes producing a final product.

In a Second Step: A second monomer emulsion was prepared following a similar procedure as in Step 1. The aqueous phase was built by mixing in a 2-liter beaker, 138 g acrylamide (50 wt %), 0.3 g Trilon C, 197 g ADAME Quat (80 wt %), 40 g water and 0.05 g formic aid. While stirring the pH was adjusted to 3 using sulphuric acid. Then, the organic phase was prepared mixing 10 g Zephrym 7053, 2.5 g Degacryl 3059 L, 6.4 g Intrasol FA1218/5 and 125 g paraffin oil in a second 2 L beaker. The aqueous phase was charged to the oil phase under vigorous stirring followed by mixing with a homogenizer to obtain a stable water-in-oil emulsion.

The inverse monomer emulsion prepared in the second step was combined with the first emulsion and the temperature of the combined emulsions (first-step emulsion and second-step emulsion) was adjusted to 63±1° C. after 30 min of air stripping. Polymerization of the mixture was initiated using 1 wt. % V-65 in oil. The amount of distillate under negative pressure was 55 ml. After distillation, the vacuum was removed. The residual monomers of the second part could react adiabatically reaching a maximum temperature of approx. 68° C. The emulsion was stirred for further 15 min. The vacuum was re-applied, and the polymerized solution was allowed to cool down to 40° C. Two grams of sodium peroxodisulfate (25 wt. % of the total emulsion) and 11 g sodium bisulfite (25 wt. % of the total emulsion) were added to the emulsion under stirring to reduce the monomer content. Finally, an ethoxylated alcohol activator was added to the final product.

### Example 1—Dewatering of an Aqueous Sludge

Samples of aqueous sludge was obtained from three different wastewater facilities located in Germany, i.e. Koln; Angertal; and Essity Mannheim. From each facility, two 500 milliliter (ml) samples of sludge were treated with two different dosages of a standard drainage aid that were used as a benchmark in the study. The sludge from each of the facilities was treated with two different dosage levels as indicated in Table 1. The samples were sheared at 1000 rpm with a four-fingered stirrer for 10-20 seconds, to simulate the centrifuges used in the dewatering facilities. The aqueous sludge was dewatered using a 315 micron (μm) metallic sieve. The amount of filtrate was measured, and the clarity of the filtrate determined using a graduated measuring wedge.

A plexiglass disc was used to cover the filter cake that remained in the sieve and a 10-kilogram (kg) weight was placed on top of the plexiglass disc for 1 minute at which time cake compactness was evaluated by visual inspection to determine if the filter cakes press ability was good, fair, or bad. Second, a part of the pressed filter cake (weighted) with placed in a heating oven at 105° C. overnight. The dried filter cake was weighed back and the total solids (TS) of the cake was noted.

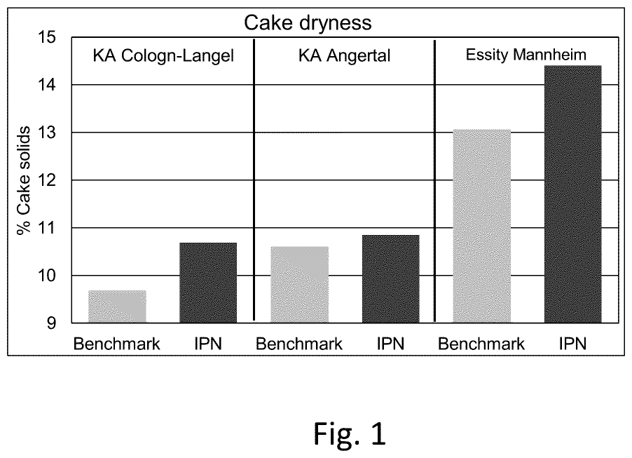

Results of dewatering the sludge from the above mills used in the study can be found in Table 1 and FIG. 1.

TABLE 1
KA Köln-Langel Sludge

| | 220 ppm = 9.6 kg/t | | | 260 ppm = 11.3 kg/t | | |
|---|---|---|---|---|---|---|
| | Sedimentation | | TS cake | Sedimentation | | TS cake |
| | time [s] | clariy | solid [%] | time [s] | clariy | solid [%] |
| New Composition | 8 | 16 | 10.5 | 3 | 20 | 10.8 |
| Standard | 20 | 5 | 9.2 | 8 | 9 | 10.1 |

KA Angertal Sludge

| | 290 ppm | | | 330 ppm | | |
|---|---|---|---|---|---|---|
| | Sedimentation | | TS cake | Sedimentation | | TS cake |
| | time [s] | clariy | solid [%] | time [s] | clariy | solid [%] |
| New Composition | <3 | 44 | 10.6 | <3 | 28 | 11.1 |
| Standard | 16 | 9 | 10.3 | 5 | 17 | 10.9 |

Essity Mannheim

| | 300 ppm = 9.0 kg/t | | | 340 ppm = 10.1 kg/t | | |
|---|---|---|---|---|---|---|
| | Sedimentation | | TS cake | Sedimentation | | TS cake |
| | time [s] | clariy | solid [%] | time [s] | clariy | solid [%] |
| IPN Composition | 5 | 8 | 14.6 | <3 | 10 | 14.2 |
| Standard | 13 | 1 | 13.0 | 5 | 3 | 13.2 |

| | |
|---|---|
| 220 ppm = 9.6 kg/t | 260 ppm = 11.3 kg/t |

Sedimentation (time for 300 ml filtrate): lower is better.
Clarity (filtrate in turbidity wedge): higher is better.
TS cake solid (105° C., overnight): higher is better.

Results shown in Table 1, indicates that the cake dryness of the “IPN” compositions provided an improvement of >1% point with cationic IPN emulsions compared to the Standard benchmark from 3 different wastewater treatment plants.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. An interpenetrating polymer network (IPN) composition comprising:
a first inverse water-in-oil emulsion polymer; and
a second inverse water-in-oil emulsion polymer physically interlaced with said first inverse water-in-oil emulsion polymer;
wherein said first inverse water-in-oil emulsion polymer comprises the polymerization reaction product of:
a first ethylenically unsaturated nonionic monomer chosen from acrylamides and derivatives thereof, an acrylic acid and derivatives thereof, and combinations thereof;
a first ethylenically unsaturated cationic monomer; and
a first cross-linking agent; and
wherein said second inverse water-in-oil emulsion polymer comprises the polymerization reaction product of:
a second ethylenically unsaturated nonionic monomer chosen from acrylamides and derivatives thereof, acrylic acids and derivatives thereof, and combinations thereof;
a second ethylenically unsaturated cationic monomer; and
a second cross-linking agent.

2. The composition according to claim 1, wherein the ratio of the first inverse water-in-oil emulsion polymer to the second inverse water-in-oil emulsion polymer is from about 80:20 to about 20:80 based on the total weight of the IPN composition.

3. The composition according to claim 1, wherein the ratio of the first inverse water-in-oil emulsion polymer to the second inverse water-in-oil emulsion polymer is from about 1:3, or 1:1 or about 3:1 based on the total weight of the IPN composition.

4. The composition according to claim 1, wherein the first and second ethylenically unsaturated nonionic monomer is the same or different and comprises an acrylamide or derivatives such as (meth)acrylamide, N-methyl(meth)acrylamide, N,N-dimethyl(meth)acrylamide, N-ethyl(meth)acrylamide, N,N-diethyl(meth)acrylamide, N-methyl-N-ethyl(meth)-acrylamide, N-isopropyl(meth)acrylamide, and N-hydroxyethyl(meth)acrylamide.

5. The composition according to claim 1, wherein the first and second ethylenically unsaturated cationic monomer is the same or different and chosen from acryloyloxy)ethyl)trimethylammonium chloride, 2-acryloxyethyltrimethylammonium chloride, dimethylaminoethyl acrylate, dimethylaminoethyl acrylate methyl chloride quat., 2-((1-oxo-2-propenyl)oxy)-N,N,N-trimethylethanaminium chloride, (2-(dimethylamino)ethyl acrylate methochloride), N,N,N-trimethyl-2-((1-oxo-2-propenyl)oxy)chloride, (2-(acryloyloxy)ethyl)trimethylammonium chloride, (2-((1-oxo-2-propenyl)oxy)-N,N,N-trimethylchloride, N,N,N-trimethyl-2-((1-oxo-2-propenyl)oxy)chloride, (2-acryloyloxyethyl)-N,N,N-trimethylammonium chloride, 2-(acryloyloxy)-N,N,N-trimethylethanaminium chloride, and combinations thereof.

6. The composition according to claim 1, wherein the first and second cross-linking agent is the same or different and chosen from N,N-methylene bis acrylamide (MBA), tetraallyl ammonium chloride (TAAC), and combinations thereof.

7. The composition according to claim 1, wherein the first and second cross-linking agent is independently present in an amount of about 0.5 ppm to about 25 ppm by weight or about 1.0 ppm to about 20 ppm by weight, based on the total weight of IPN composition.

8. The composition according to claim 1, wherein the first and/or second water-in-oil emulsion polymer further comprises an additive chosen from chelating agents, surfactants, stabilizers, oils, and combinations thereof.

9. A method of dewatering aqueous sludge comprising:
treating the aqueous sludge with an interpenetrating network emulsion polymer composition comprising:
a. in a first step;
preparing a first inverse water-in-oil emulsion polymer comprising the polymerization reaction product of:
a first ethylenically unsaturated nonionic monomer chosen from acrylamides and derivatives thereof, an acrylic acid and derivatives thereof, and combinations thereof;
a first ethylenically unsaturated cationic monomer; and
a first cross-linking agent; and
b. in a second step;
preparing a second inverse water-in-oil emulsion polymer comprising the polymerization reaction product of:
a second ethylenically unsaturated nonionic monomer chosen from acrylamides and derivatives thereof, acrylic acids and derivatives thereof, and combinations thereof;
a second ethylenically unsaturated cationic monomer; and
a second cross-linking agent;
wherein the polymerization of the second inverse water-in-oil emulsion polymer is initiated in-situ with the first inverse water-in-oil emulsion polymer, producing a second inverse water-in-oil emulsion polymer that is physically interlaced with the first inverse water-in-oil emulsion polymer creating an interpenetrating polymer network (IPN) composition.

10. The method according to claim 9, wherein the polymerization in-situ is initiated using an initiator chosen from peroxides, persulfates, and azo compounds such as 2,2′-azobis(2,4-dimethyl valeronitrile.

11. The method according to claim 9, wherein initiation of the polymerization of the second water-in-oil emulsion in-situ with the first water-in-oil emulsion polymer is initiated with a charge of initiator in an amount of about 250 ppm or less based on the total weight of the IPN composition.

12. The method according to claim 9, wherein the initiator is present in an amount of about 0.0025 wt. % to about 0.0075 wt. %, or about 0.0040 wt. % to about 70%, or about 0.0050 wt. % to about 0.0065 wt. %, based on the total weight of the IPN composition.

13. The method according to claim 9, wherein the first and second ethylenically unsaturated nonionic monomer is the same or different and comprises an acrylamide or derivatives thereof.

14. The method according to claim 9, wherein the first and second ethylenically unsaturated cationic monomer is the same or different and is chosen from acryloyloxy)ethyl)trimethylammonium chloride, 2-acryloxyethyltrimethylammonium chloride, dimethylaminoethyl acrylate, dimethylaminoethyl acrylate methyl chloride quat., 2-((1-oxo-2-propenyl)oxy)-N,N,N-trimethylethanaminium chloride, (2-(dimethylamino)ethyl acrylate methochloride), N,N,N-trimethyl-2-((1-oxo-2-propenyl)oxy)chloride, (2-(acryloyloxy)ethyl)trimethylammonium chloride, (2-((1-oxo-2-propenyl)oxy)-N,N,N-trimethylchloride, N,N,N-trimethyl-2-((1-oxo-2-propenyl)oxy)chloride, (2-acryloyloxyethyl)-N,N,N-trimethylammonium chloride, 2-(acryloyloxy)-N,N,N-trimethylethanaminium chloride, and combinations thereof.

15. The method according to claim 9, wherein the first and second cross-linking agent is the same or different and is chosen from is chosen from N,N-methylene bis acrylamide (MBA), tetraallyl ammonium chloride (TAAC), and combinations thereof.

16. The method according to claim 15, wherein the first and second cross-linking agent is independently present in an amount of about 0.5 ppm to about 25 ppm by weight or about 1.0 ppm to about 20 ppm by weight, based on the total weight of the first or second water-in-oil emulsion polymer, respectively.

17. The method according to claim 9, wherein the aqueous sludge being treated is from waste water from municipal processes, industrial processes, papermaking processes, or mining sludge coming from tailings dewatering.

18. A method of increasing cake dryness in sludge dewatering processes comprising:
treating the aqueous sludge with an interpenetrating network emulsion polymer composition comprising:
a. in a first step;
preparing a first inverse water-in-oil emulsion polymer comprising the polymerization reaction product of:
a first ethylenically unsaturated nonionic monomer chosen from acrylamides and derivatives thereof, an acrylic acid and derivatives thereof, and combinations thereof;
a first ethylenically unsaturated cationic monomer; and
a first cross-linking agent; and
b. in a second step;
preparing a second inverse water-in-oil emulsion polymer comprising the polymerization reaction product of:
a second ethylenically unsaturated nonionic monomer chosen from acrylamides and derivatives thereof, acrylic acids and derivatives thereof, and combinations thereof;
a second ethylenically unsaturated cationic monomer; and
a second cross-linking agent;
wherein the polymerization of the second inverse water-in-oil emulsion polymer is initiated in-situ with the first inverse water-in-oil emulsion polymer, producing a second inverse water-in-oil emulsion polymer that is physically interlaced with the first inverse water-in-oil emulsion creating an interpenetrating polymer network (IPN) composition.

19. The method according to claim 18, wherein the polymerization in-situ is initiated using an initiator chosen from peroxides, persulfates, and azo compounds, and 2,2′-azobis(2,4-dimethyl valeronitrile.

20. The method according to claim 18, wherein initiation of the polymerization of the second water-in-oil emulsion polymer in-situ with the first water-in-oil emulsion polymer is initiated with a charge of initiator in an amount of about 250 ppm or less based on the total weight of the IPN composition.
